(19) United States
(12) Patent Application Publication
(10) Pub. No.: US 2023/0339130 A1
(43) Pub. Date: Oct. 26, 2023

(54) RAZOR CARTRIDGE

(71) Applicants: Société BIC, Clichy Cedex (FR); BIC Violex Single Member S.A., Anoixi (GR)

(72) Inventors: Christopher John WRIGHT, London (GB); David Michael DUFFY, Prilly Vaud (CH); Anestis TSEGENIDIS, Anoixi (GR); Konstantinos MISICHRONIS, Anoixi (GR); Panagiotis GIANNOPOULOS, Anoixi (GR); Efthymios SALTAS, Anoixi (GR); Dimitrios KLIMANOGLOU, Anoixi (GR); Christos GALANIS, Anoixi (GR)

(73) Assignees: Société BIC, Clichy Cedex (FR); BIC Violex Single Member S.A., Anoixi (GR)

(21) Appl. No.: 17/759,630

(22) PCT Filed: Feb. 24, 2021
(86) PCT No.: PCT/EP2021/054564

§ 371 Date: Jul. 28, 2022

(30) Foreign Application Priority Data
Feb. 24, 2020 (EP) 20159064.3

(51) Int. Cl. B26B 21/40

(52) U.S. Cl. CPC B26B 21/4018

(57) ABSTRACT

A razor cartridge includes a skin-contacting surface configured to contact a user's skin surface during a shaving operation. The skin-contacting surface includes a variable friction resistance element having a frictional resistance which is dependent on a motion direction of the razor cartridge over the user's skin surface.

### CROSS REFERENCE TO OTHER APPLICATIONS

This application is a National Stage Application of the International Application No. PCT/EP2021/054564, 24 Feb. 2020, now published as WO/2021/170662 and which claims priority to the European patent application EP20159064 filed on 24 Feb. 2020, its content being incorporated herein by reference.

### TECHNICAL FIELD

The aspects described in the following disclosure relate to a razor cartridge, a kit of parts, a razor and a method for avoiding skin irritation during a shaving operation by a user with a razor.

### BACKGROUND

Razors also known as safety razors, have a razor cartridge that is permanently or removably attached to a razor handle which, in use, is oriented in shaving direction. Razor cartridges typically comprise one or more cutting members, each including a blade, mounted perpendicular to the shaving direction. Razor cartridges are also typically (but not necessarily) provided with a guard (at a leading longitudinal side of the razor cartridge in the shaving direction) and a cap (at a trailing longitudinal side of the razor cartridge in the shaving direction). In use, a user holds the razor handle in the shaving direction and brings the razor cartridge into contact with a portion of skin defining a shaving plane.

Typically, the shaving plane is defined as the tangential line intersecting the first and second skin contact points of, for example, cutting edges of the razor cartridge. More simply, the shaving plane may be approximated as a line between the highest points on the skin-contacting surfaced of a razor cartridge—for example, the flat plane between the top of a guard and the top of a cap of the razor cartridge. During a shaving operation, movement of the razor handle causes the blades of the razor cartridge to be moved across the shaving plane in the shaving direction, enabling the blades to remove unwanted hair.

However, in such a shaving operation and due to the direct contact of the blades to the skin, discomfort may be present and skin irritations or skin cuts may occur. The skin irritations may be, for example, redness, burning and stinging subsequent to a shaving operation. This may be the result of the blades contacting the skin and a corresponding abrasion or cutting of outer skin layers. In order to reduce skin irritations, discomfort and skin cuts during shaving operations, various approaches have been pursued in the state of the art. Some razors are known in the state of the art that improve gliding characteristics over the skin during a shaving operation using materials that provide low friction with the skin surface and reduce skin irritations. However, improved gliding characteristics in shaving direction might not avoid skin cuts that may occur by a movement of the razor in a direction perpendicular to the shaving direction or in an oblique direction.

Accordingly, the present disclosure aims to provide a razor cartridge through which the shaving performance of a razor and user safety during a shaving operation is further improved. In particular, the present disclosure aims at preventing skin cuts that may occur by a movement of the razor cartridge in a direction perpendicular to the shaving direction and/or in oblique direction.

### SUMMARY

The present disclosure relates to a razor cartridge according to claim 1.

In aspects, the razor cartridge comprises a skin-contacting surface, which is configured to contact a user's skin surface during a shaving operation. The skin-contacting surface includes a variable friction resistance element having a frictional resistance which is dependent on a motion direction of the razor cartridge over the user's skin surface. The razor cartridge defines a shaving direction and a perpendicular direction. The variable friction resistance element is adapted to prevent movement in the perpendicular direction such that when moving the razor cartridge in the perpendicular direction the variable friction resistance element is transitioned to an engaged state. In the engaged state, the variable friction resistance element is configured to increase a friction contact area with the skin surface.

It has been found that shave-induced skin irritations, discomfort and skin cuts can be avoided or at least reduced by inhibiting a movement in a direction perpendicular to the shaving direction, defined as a perpendicular direction. In addition, the razor cartridge defines an oblique direction, that is a direction combined of perpendicular direction and shaving direction, being under an angle with respect to the perpendicular direction. The variable friction resistance element has an anisotropic behaviour and can engage with the skin surface when moving in the perpendicular direction and/or the oblique direction. In the shaving direction, improved sliding characteristics of the razor cartridge can be used in order to further reduce shave-induced skin-irritations and discomfort. Thereby, if a user deviates from a movement in shaving direction and moves the razor in a direction perpendicular to the shaving direction or under an angle to the perpendicular direction, i.e. in particular the oblique direction, the razor experiences an increased frictional resistance of the variable friction resistance element with respect to the skin surface. In this manner, the variable friction resistance element can function as a “stop” against sideways movement or movement in a direction that is different, perpendicular or oblique, to the shaving direction. In this manner, sideways motion (perpendicular motion and/or oblique motion) of the razor cartridge can be prevented or at least reduced. This increases the user's safety during a shaving operation. This can lead to reduced skin irritations, reduced discomfort and can avoid, or at least reduce, skin nicks and cuts during a shaving operation.

In the following specification and claims, the term “cutting member” means a component of a razor cartridge that, in use, contacts the skin of a user and cuts protruding hairs. A cutting member can mean at least a razor blade having a blade with a cutting edge glued, or laser welded, to a separate bent support member. The bent support member is fitted into a cutting member support slot in-between two opposed cutting member guides, such as protrusions from a shaving direction frame member of the razor cartridge. The blade can be attached to the face of the bent support member that faces towards a user of the razor cartridge, in use. Alternatively, the blade can be attached to the face of the bent support member that faces away from a user of the razor cartridge, in use. In this latter case, each cutting member has two contact points with the skin of the user, the blade edge, and the distal end of the bent support member, to thus reduce pressure on the user's skin. Alternatively, the cutting member may be a “bent blade”. This is an integrally formed cutting member comprising a radiused bend, and a cutting edge formed at a distal end of the radiused bend.

A “group of cutting members” may consist of the same type of cutting members, or may comprise at least one bent blade, or another type of blade for example.

In the following specification and claims, the term “leading” means the side of the razor cartridge that contacts a portion of a user's skin first, in normal use, i.e. during shaving.

In the following specification and claims, the term “trailing” means the side of the razor cartridge that contacts a portion of a user's skin last, in normal use, i.e. during shaving.

In the following specification and claims, the term “variable friction resistance element” is a component of the skin-contacting surface and is adapted to vary or change its frictional resistance. Consequently, the frictional resistance can be increased or reduced. The ability of the variable friction resistance element “to vary” its frictional resistance can but is not necessarily the result of a dynamic behaviour of the variable friction resistance element (e.g., a change in its configuration such as the surface profile). In other words, the variable friction resistance element can have a static configuration but nevertheless provide for an anisotropic frictional resistance. In other examples, a shape change or another change in the configuration of the variable friction resistance element having anisotropic characteristics can directly impact the frictional resistance on the skin surface. This shape change can be triggered by the motion of the razor cartridge over the user's skin surface.

In the following specification and claims, the term “frictional resistance” refers to a force that acts between two bodies contacting each other. The frictional resistance impedes the movement of the bodies against each other. The frictional resistance occurs between the skin surface and the skin-contacting surface comprising the variable friction resistance element of the razor cartridge. The frictional resistance depends on a friction coefficient and on the normal force applied to the razor cartridge during shaving. The normal force in turn is determined by the product of a tensile stress of the variable friction resistance element when engaging with the skin surface, and a friction contact area between variable friction resistance element and skin surface. The variable friction resistance element can be adapted to vary its friction coefficient and/or the contact area to the skin surface. As follows, the normal force is dependent on the motion direction of the razor cartridge and the contact pressure to the skin surface.

In the following specification and claims, the term “motion direction” of the razor cartridge is defined as the movement starting from an initial state or point, whereby the razor cartridge is moved from this initial state in a respective direction. Two particular directions are a shaving direction and a perpendicular direction, wherein the perpendicular direction is perpendicular to the shaving direction. In examples, the razor cartridge is placed on the user's skin surface wherein the razor cartridge is in the initial state. From this initial state, the razor cartridge is moved in shaving direction in order to achieve a shaving effect, i.e. to shave. In examples, the razor cartridge can be moved from the initial state in perpendicular direction, for example to the left or to the right with respect to the shaving direction. However, such a movement in perpendicular direction might lead to skin nicks and cuts, skin irritations and discomfort. In examples, from the initial state the razor cartridge can be moved in a direction combined of shaving direction and perpendicular direction, referring to an oblique direction. Starting from an initial state or point, a motion in oblique direction can be described as a motion under an angle with respect to the perpendicular direction, i.e. a motion in oblique direction also includes a motion component in shaving direction.

The expression “dependent on the motion direction” does not encompass a forward direction and a backward direction (or other anti-parallel directions) as two different directions. Rather, two different directions forming an angle other than 180° degrees are meant.

Additional details and features are described in reference to the drawings as follows.

### BRIEF DESCRIPTION OF THE DRAWINGS

Other characteristics will be apparent from the accompanying drawings, which form a part of this disclosure. The drawings are intended to further explain the present disclosure and to enable a person skilled in the art to practice it. However, the drawings are intended as non-limiting examples. Common reference numerals on different figures indicate like or similar features.

FIGS. 1A and 1B are schematics views of a razor cartridge with a variable friction resistance element comprising structured protrusions.

FIG. 1C is a schematic view of a structured protrusion in the form of a concertina patterning of a ridge.

FIG. 2A to 2C are schematic views of a razor cartridge with a variable friction resistance element comprising a corrugated shape.

FIGS. 3A and 3B are schematics views of a razor cartridge having structured protrusions in the form of gripping elements.

FIG. 4 is a perspective partial exploded view of a razor cartridge.

FIGS. 5 and 6 are schematic cutaway side views of a razor cartridge taken from the embodiment of FIG. 4 along axis P-Q.

FIGS. 7 and 8 are perspective views of a razor comprising a razor handle and a razor cartridge.

FIGS. 9 and 10 show schematic views razor cartridge including a skin contacting member including a variable friction resistance element.

### DETAILED DESCRIPTION

Embodiments of the razor cartridge will be described in reference to the drawings as follows.

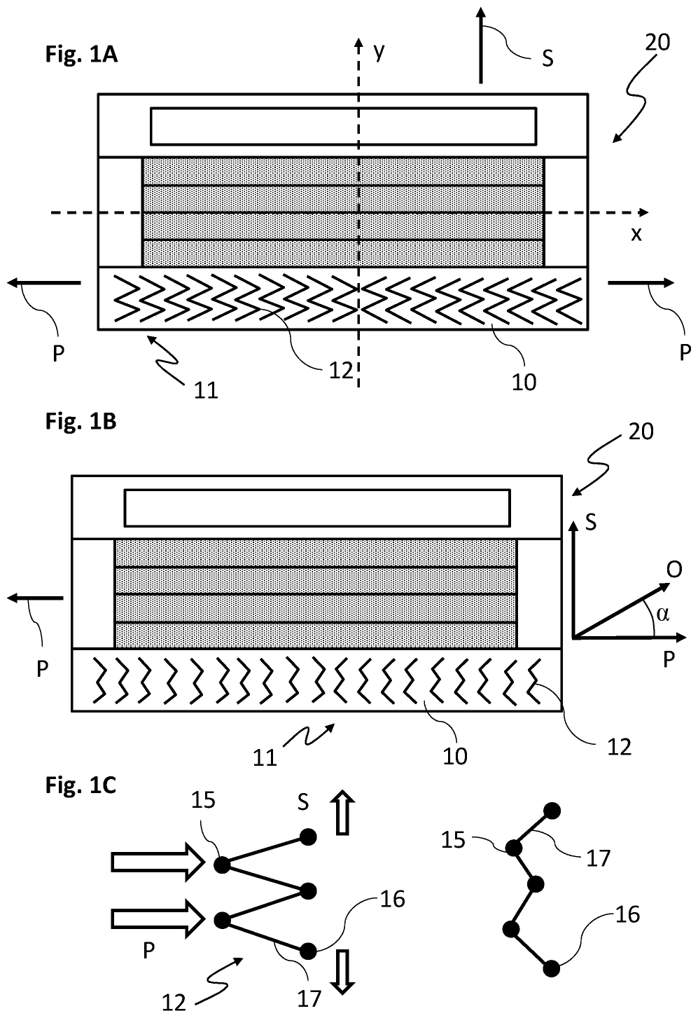

FIGS. 1A and 1B are schematic views of a razor cartridge 20 according to a first aspect. The razor cartridge comprises a skin-contacting surface 10 configured to contact a user's skin surface K during a shaving operation. The skin-contacting surface 10 of the razor cartridge 20 faces and contacts the skin surface K during a shaving operation. The skin-contacting surface 10 includes a variable friction resistance element 11 having a frictional resistance which is dependent on a motion direction of the razor cartridge 20 over the user's skin surface K. In examples, the skin-contacting surface may include more than one variable friction resistance element having frictional resistance that depend on motion direction. The frictional resistance is generated between the skin surface K and the skin contacting surface 10 during a shaving operation. The razor cartridge 20 defines a shaving direction S and a direction perpendicular to the shaving direction S in a plane SCP defined by the skin contacting surface 10, namely a perpendicular direction P. In addition, the razor cartridge defines an oblique direction O, that is defined as a direction combined of perpendicular direction P and shaving direction S, at an angle α with respect to the perpendicular direction P, as shown e.g. in FIG. 1B. In examples, the angle α may have values between 0° and 70°, measured from the perpendicular direction P to the oblique direction O. With the above-mentioned variable friction resistance element 11, skin irritations, discomfort and skin cuts can be avoided, or at least reduced, by inhibiting a movement of the razor cartridge 20 in the perpendicular direction P and/or in oblique direction O. In shaving direction S, improved sliding characteristics can be used with respect to skin-irritations and discomfort during a shaving operation. In particular, the variable friction resistance element 11 has an anisotropic behaviour and engages with the skin surface K when moving in perpendicular direction P and/or oblique direction O. Thereby, the frictional resistance of the variable friction resistance element 11 with respect to the skin surface K highly increases and functions as a “stop”. In particular, sideways motion, and/or oblique motion and/or movement in perpendicular direction P being risky for skin nicks and/or cuts of the razor cartridge 20 is prevented or at least reduced. As a result, a user's safety is increased during a shaving operation.

The arrangements described herein can minimally impact the ability of the razor cartridge to glide in the shaving direction S in some examples. The variable friction resistance element 11 can be made of suitable materials having characteristics that provide a specific frictional resistance, dependent on the motion direction. Besides a specific structure and shape of the variable friction resistance element 11, important properties can be that the variable friction resistance element 11 has a degree of flexibility and material which allows appropriate skin contact and tensioning to the skin surface K when moving in perpendicular direction P and/or oblique direction O. In examples, the variable friction resistance element 11 can comprise Polydimethylsiloxan (PDMS), which, together with the structure and shape of the variable friction resistance element, can provide suitable variable friction characteristics.

When moving the razor cartridge 20 in perpendicular direction P, the frictional resistance is higher, in examples at least two times higher, specifically at least three times higher than when moving the razor cartridge 20 in the shaving direction S. In embodiments, the frictional resistance can be at least ten times higher by a movement of the razor cartridge 20 in the perpendicular direction P than by a movement of the razor cartridge 20 in shaving direction S. When moving the razor cartridge 20 in oblique direction O, the frictional resistance is higher than when moving the razor cartridge 20 in the shaving direction S.

As stated herein, the frictional resistance is generated between the skin surface K and the skin-contacting surface 10 comprising the variable friction resistance element 11 of the razor cartridge 11. The frictional resistance depends on a friction coefficient μ and on normal force FN applied to the razor cartridge 20 during shaving. The normal force FN in turn is determined by the product of a tensile stress a of the variable friction resistance element 11 when engaging with the skin surface K, and a friction contact area A between variable friction resistance element 11 and skin surface K. In shaving direction S, the frictional resistance may be low, which means that low values for the friction coefficient, tensile stress and contact area are at least partly desirable. In perpendicular direction P and/or oblique direction O, on the other hand, the frictional resistance may be higher, so that movement relative to the skin surface K can be inhibited. Consequently, higher values for friction coefficient, tensile stress and contact area are at least partly desirable.

When moving the razor cartridge 20 in the shaving direction S, the frictional resistance is determined by a friction coefficient μ_{S} between skin-contacting surface 10, i.e. variable friction resistance element 11, and the skin surface K, and a normal force F_{SN}. The friction coefficient in shaving direction S may have a value of μ_{S}≤0.35, in examples μ_{S}≤0.2, and specifically μ_{S}≤0.15. The normal force F_{SN} is defined as the force with which the razor cartridge 20 is applied on the skin surface K. In particular, the frictional resistance is determined by the product of friction coefficient μ_{S} and normal force F_{SN} in shaving direction S. In general, the higher the friction coefficient, the higher the frictional resistance. In other words, the friction coefficient μ_{S} in shaving direction may be between 0.001 and 0.35, in examples between 0.01 and 0.2, and specifically between 0.01 and 0.15. In embodiments, the friction coefficient μ_{S} may be between 0.05 and 0.10. The normal force F_{SN} is determined by the product of a tensile stress σ_{S} of the variable friction resistance element 11 when engaging with the skin surface K, and a friction contact area A_{S} between variable friction resistance element 11 and skin surface K. The higher the contact area A_{S}, the higher the tensile stress and in turn the normal force (and frictional resistance). In particular, an increased contact area A_{S} leads to increased tensile stresses in the variable friction resistance element 11. The contact area A_{S} between variable friction resistance element 11 and skin surface K depends on the geometry and/or shape of the variable friction resistance element 11. By a movement in shaving direction S, the contact area A_{S} is minimized leading to a minimum tensile stress σ_{S}. In examples, the tensile stress σ_{S} may be between 0.0001 kPa and 5 kPa, in examples between 0.02 kPa and 0.5 kPa. In embodiments, the tensile stress σ_{S} can be between 0.05 kPa and 0.2 kPa.

When moving the razor cartridge 20 in the perpendicular direction P, the frictional resistance is determined by a friction coefficient μ_{P} between skin-contacting surface 10, i.e. variable friction resistance element 11, and the skin surface K, and a normal force F_{PN}. The friction coefficient in perpendicular direction P may have a value of μ_{P}≥0.15, in examples μ_{P}≥0.2, and specifically μ_{P}≥0.35. The normal force F_{PN} is defined as the force with which the razor cartridge 20 is applied on the skin surface K in the perpendicular direction P. In particular, the frictional resistance is determined by the product of friction coefficient μ_{P} and normal force F_{PN} in perpendicular direction P. In general, the higher the friction coefficient, the higher the frictional resistance. By a movement of the razor cartridge 20 in perpendicular direction P, the friction coefficient μ_{P} may be higher, in particular at least 2 times higher, in examples at least 5 times higher, and specifically at least 10 times higher than by a movement in shaving direction S. In embodiments, the friction coefficient μ_{P} can be between 0.15 and 100, in examples between 0.35 and 20, specifically between 1.0 and 10. In embodiments, the friction coefficient μ_{P} can be between 1.5 and 2.5.

The normal force F_{PN} is determined by the product of a tensile stress σ_{P} of the variable friction resistance element 11 when engaging with the skin surface K, and a friction contact area A_{P} between variable friction resistance element 11 and skin surface K. By a movement of the razor cartridge 20 in perpendicular direction P, the variable friction resistance element 11 engages with the skin surface K, resulting in an increasing contact area A_{P}, in particular, a maximum contact area. By a movement in perpendicular direction P, the contact area A_{P} may be at least 2 times higher, in examples at least 5 times higher, and specifically at least 10 times higher than by a movement in shaving direction S. Thereby, tensile stresses in the variable friction resistance element 11 increase linearly up to maximum tensile stresses. In examples, the tensile stress can be σ_{P}≥0.2 kPa, particularly σ_{P}≥0.5 kPa, specifically σ_{P}≥5 kPa. In embodiments, the tensile stress σ_{P} can be between 0.2 kPa and 1000 kPa, in examples between 0.5 kPa and 100 kPa, specifically between 2 kPa and 30 kPa. In embodiments, the tensile stress σ_{P} can be between 12 kPa and 18 kPa.
When moving the razor cartridge 20 in the oblique direction O, the frictional resistance is determined by a friction coefficient μ_{O} between skin-contacting surface 10, i.e. variable friction resistance element 11, and the skin surface K, and a normal force F_{ON}. In examples, the values for the above-mentioned parameters and the resulting frictional resistance can lie between the value ranges of shaving direction S and perpendicular direction P. The normal force F_{ON} is defined as the force with which the razor cartridge 20 is applied on the skin surface K in the oblique direction O. In particular, the frictional resistance is determined by the product of friction coefficient μ_{O} and normal force F_{ON} in oblique direction O. In general, the higher the friction coefficient, the higher the frictional resistance. By a movement of the razor cartridge 20 in oblique direction O, the friction coefficient μ_{O} can be higher than in the shaving direction S but can be lower than in the perpendicular direction P. In other words, the friction coefficient in oblique direction O may have a value of μ_{O}≥μ_{S} and μ_{O}≤μ_{P}. The specific value of μ_{O} can also be dependent on the angle α, measured between perpendicular direction P and oblique direction S.
The normal force F_{ON} is determined by the product of a tensile stress σ_{O} of the variable friction resistance element 11 when engaging with the skin surface K, and a friction contact area A_{O} between variable friction resistance element 11 and skin surface K. By a movement of the razor cartridge 20 in oblique direction O, the variable friction resistance element 11 at least partly engages with the skin surface K, resulting in an increasing contact area A_{O}. By a movement in oblique direction O, the contact area A_{O} can be higher than by a movement in shaving direction S. Thereby, tensile stresses in the variable friction resistance element 11 can increase linearly up to higher tensile stresses. For this case, the tensile stress can be σ_{O}≥σ_{S}, but σ_{O}≤ar.

It is to be noted that the specific values of the above-mentioned parameters in shaving direction S, in perpendicular direction P and/or oblique direction O can vary significantly based on the design and structure of the variable friction resistance element 11, e.g., geometry, structure, material, . . . . For the herein-mentioned value ranges of parameters μ_{S} and μ_{P}, σ_{S} and σ_{P}, as well as A_{S} and A_{P}, it is to be noted that the respective value ranges for the motion directions do not overlap. The same applies for the movement in oblique direction O. In other words, the respective values are always higher by a motion in perpendicular direction P than by a motion in shaving direction S. For example, if μ_{S}=0.15 when moving the razor cartridge 20 in shaving direction S, μ_{P} is greater than μ_{S}, e.g. 0.5, when moving the razor cartridge in the perpendicular direction S. With regard to the oblique direction O, the values can be higher than by a motion in shaving direction S but can be lower than by a motion in perpendicular direction P, dependent on the angle α and the specific structure and shape of the variable friction resistance element 11. In other words, the values for the above-mentioned parameters and the resulting frictional resistance can lie between the value ranges of shaving direction S and perpendicular direction P.

In embodiments, the variable friction resistance element 11 is adapted to inhibit a motion in the perpendicular direction P and/or in oblique direction O.

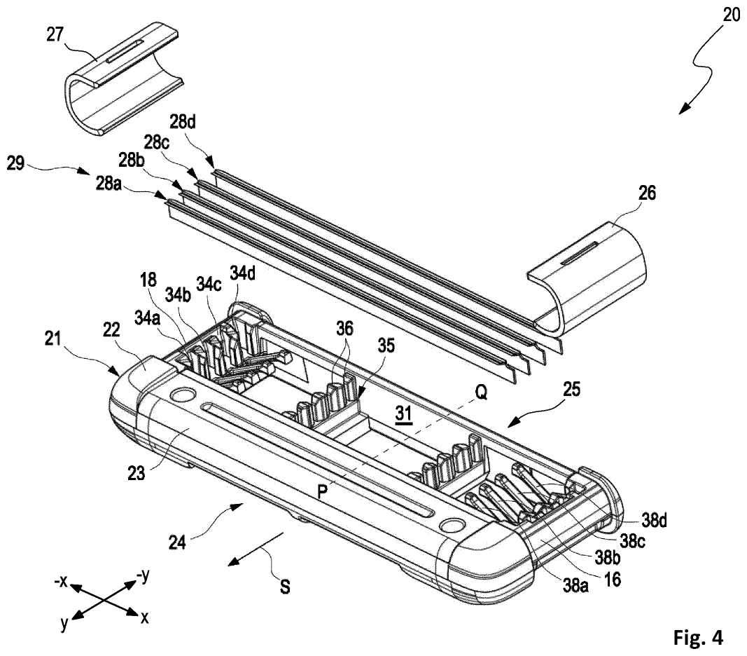

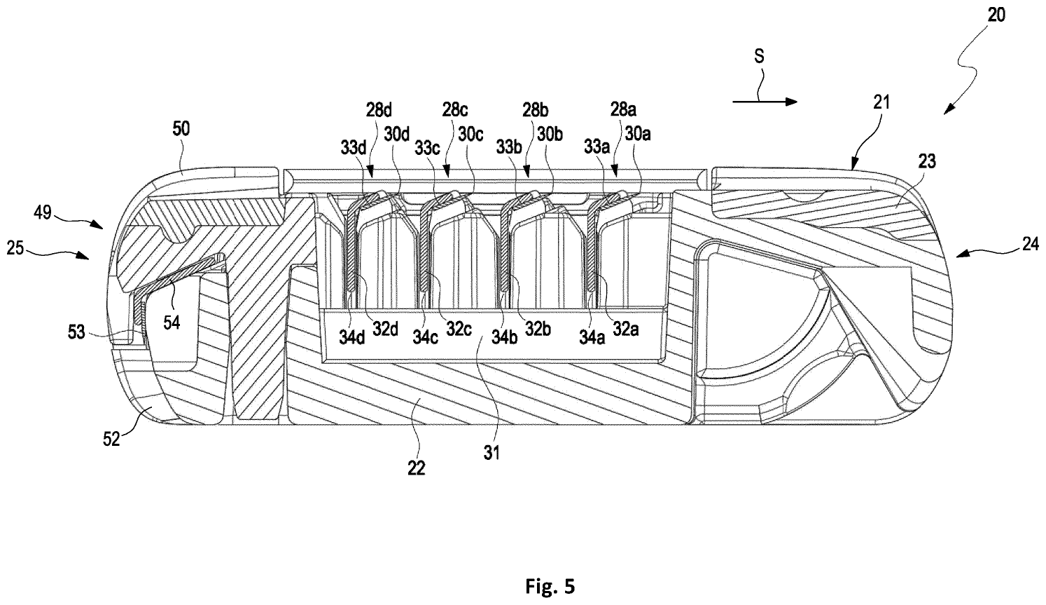

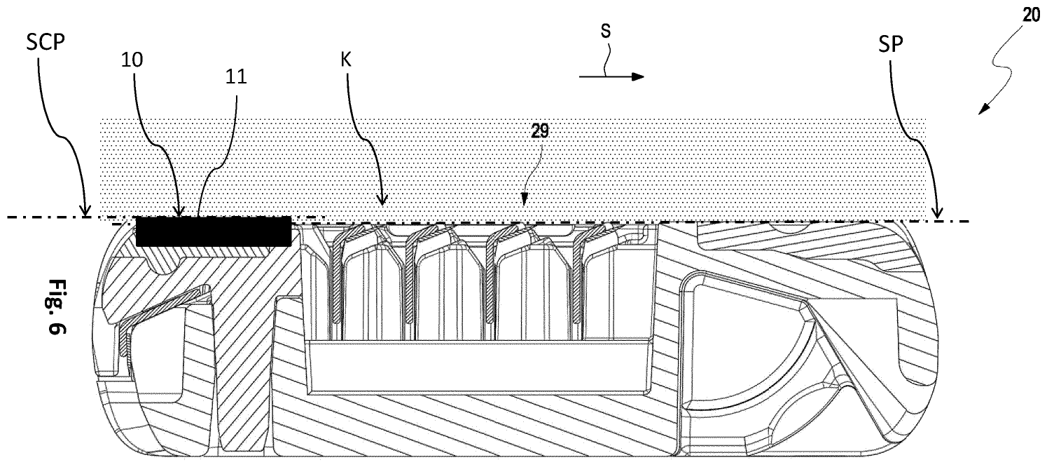

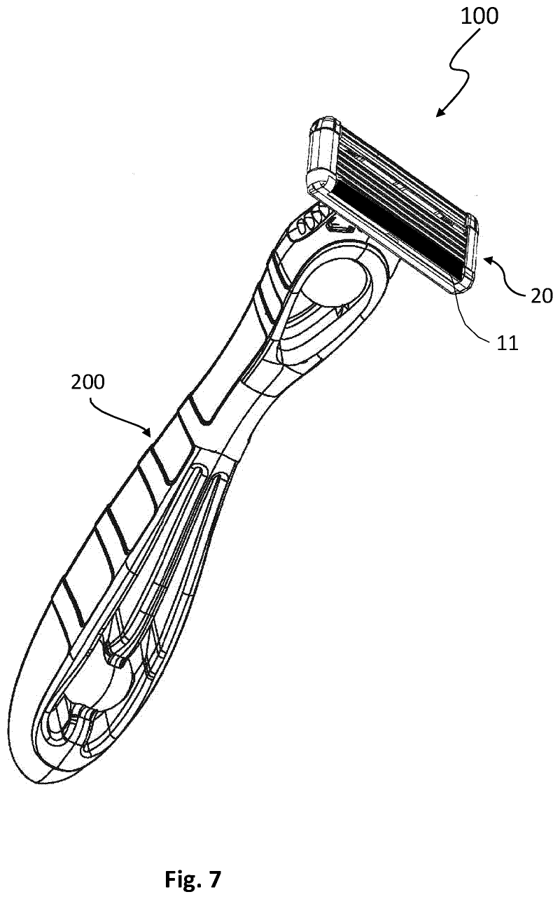

FIGS. 5 and 6 are a perspective partial exploded view and a schematic cutaway side view of a razor cartridge 20 taken from the embodiment of FIG. 4 along axis P-Q according to an aspect. “Partial exploded view” means that some minor components of the razor cartridge 20 have been omitted from the exploded view to aid clarity of the drawing.

The razor cartridge 20 comprises a frame 21. The frame 21 comprises a leading longitudinal member 24 and a trailing longitudinal member 25 and at least one shaving direction frame member 35 disposed in between, and joining, the leading longitudinal member 24 and the trailing longitudinal member 25, in a transverse direction of the razor cartridge 20. The skin-contacting surface 10 comprising the variable friction resistance element 11 can be on the surfaces of the frame 21 that face the skin surface K during a shaving operation, in particular of leading longitudinal member 24, trailing longitudinal member 25 and/or at least one shaving direction frame member 35.

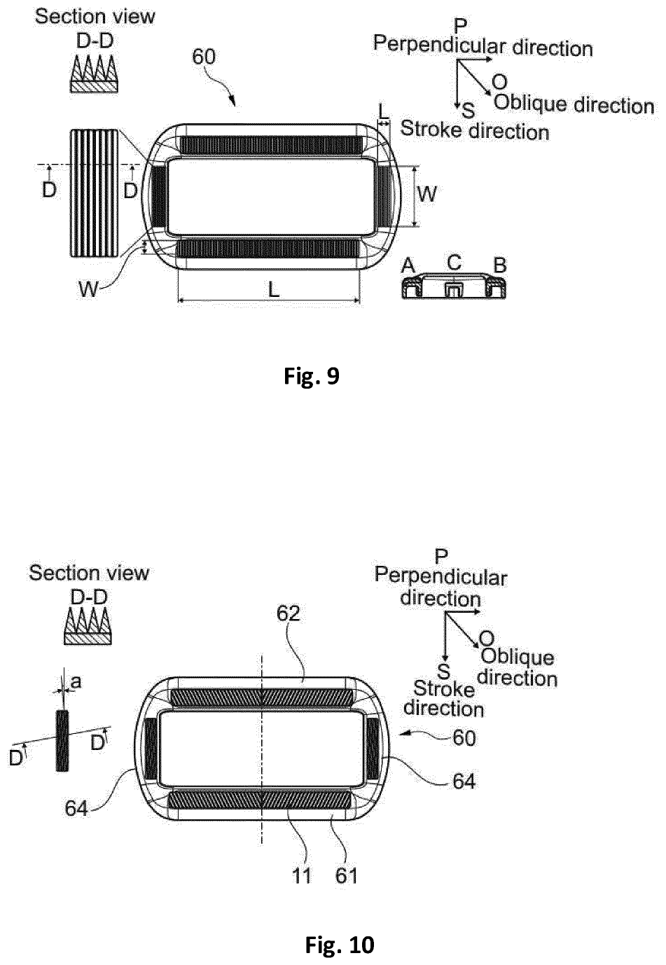

FIGS. 9 and 10 show embodiments of the razor cartridge 20 comprising a skin contacting member 60. The skin contacting member 60 or skin adaptor may be a distinct or separable component which is attachable to the frame 21. The skin contacting member 60 may be permanently connected to the frame 21 or releasably connected to the frame 21. The skin contacting member 60 may be snap fitted to the frame 21. In examples, one or more protrusions (not shown) may be provided on the frame 21 to allow the attachment, permanent or releasable, and firmly maintain the skin contacting member 60 attached onto the frame 21 after the snap fitting is occurred. The skin contacting member 60 may completely surround the frame 21. In examples, the skin contacting member may partially surround the frame.
The skin contacting member 60 may comprise a leading skin contacting surface 61 extending in front of the cutting members 28a-d and a trailing skin contacting surface 62 extending rearward of the cutting members 28a-d. The leading skin contacting surface 61 may be located in front of the forward-most blade and the trailing skin contacting surface 62 may be located aft of the aft-most blade, when the skin contacting member 60 is mounted on the frame 21. The skin contacting member 60 may further comprise a pair of lateral skin contacting surfaces 64 connecting the leading skin contacting surface 61 and the trailing skin contacting surface 62, on either side of the frame 21.
In embodiments, the friction resistance element 11 may be provided on one or more of the skin contacting surfaces 61, 62, 64 of the skin contacting member 60 that face the skin surface K during a shaving operation. In examples, on the friction resistance element may be provided on the leading skin contacting surface 61, the trailing skin contact surface 62 and/or on one or more of the lateral skin contacting surfaces 64. All potential combinations of the location of the friction resistance element 11 are foreseen, for example the friction resistance element 11 may be provided only on the leading skin contacting surface 61 and/or the trailing skin contacting surface 62.
In examples, the friction resistance element may only be provided on the leading skin contacting surface 61 and in one of the lateral skin contacting surfaces 64. In examples, the lateral skin contacting surfaces 64 may have an elevation (not shown) that is higher compared to the leading and the trailing skin contacting surfaces 61, 62. When the friction resistance element 11 is provided on at least one of the lateral skin contacting surfaces 64, this results in higher pressure being distributed in these lateral areas which results in increased sensitivity of the gripping effect of the friction resistance element 11.
Therefore, the skin contacting member 60 provides for a larger available area for placing the friction resistance element thus increasing the friction resistance in case of unintentional sideward movement by the user during shaving. This provides for a mitigated risk of micro injuries and irritation of the skin during shaving.
In examples, the friction resistance element 11 may be co-injected to corresponding cavities (not shown) of the desired surface of the skin contacting member 60. A length L of the cavity of the leading and the trailing skin contact surface 61, 62, and consequently a length of the friction resistance element 11, may vary between 25-40 mm, specifically the length may be of about 33 mm. Further, a width W of the friction resistance element when placed on the leading skin contacting surface and/or the trailing skin contacting surface may be between 2-4 mm and more specifically of about 3 mm with a relevant depth of about 0.7 mm. In examples, when the friction resistance element 11 is placed on one or more of the lateral skin contacting surfaces 64 of the skin contacting member 60, the length of the friction resistance element may be between 1.5-3 mm and more specifically about 2 mm, while the width may be between 7-10 mm and more specifically about 9 mm, with a relevant depth of 0.15-0.5 mm, more specifically about 0.25 mm

The at least one shaving direction frame member 35 comprises a plurality of cutting member guides 36a-d defining a plurality of cutting member support slots, each cutting member support slot configured to accommodate a longitudinal cutting member.

The shaving direction S is depicted in FIG. 4 using arrow S. Typically, a shaving plane SP is defined as the tangential line intersecting the first and second skin contact points of, for example, cutting edges of the razor cartridge 20. More simply, the shaving plane may be approximated as a line between the highest points on the skin-contacting surfaced of a razor cartridge—for example, the flat plane between the top of a guard and the top of a cap of the razor cartridge. During a shaving operation, movement of a razor handle 200 causes the blades of the razor cartridge 20 to be moved across the shaving plane SP in the shaving direction S, enabling the blades to remove unwanted hair. and is translated by the user across the shaving plane SP in the direction of arrow S. In use, the razor cartridge 20 contacts the shaving plane SP. For clarification, the skin-contacting surface 10 including the variable friction resistance element 11 is arranged on the razor cartridge 20 and contacts the skin surface K during a shaving operation. However, a plane SCP defined by the skin-contacting surface 10 does not have to be necessarily in the same plane as the shaving plane SP, since the variable friction resistance element 11 might protrude with respect to the shaving plane SP.

A frame 21 may be fabricated partially or completely of synthetic materials, such as plastic, resin, or elastomers. The frame 21 comprises a platform member 22. A guard member 23 is, in examples, provided as a substantially longitudinal edge of the razor cartridge 20. In use, the guard member 23 is the first portion of the razor cartridge 20 to contact uncut hairs, and it is thus located at a leading longitudinal member 24 of the razor cartridge 20. The side of the razor cartridge 20 opposite to the leading longitudinal member 24 of the razor cartridge 20 and opposite to the shaving direction S is the trailing longitudinal member 25 of the razor cartridge 20. The trailing longitudinal member 25 is thus the final portion of the razor cartridge 20 to contact the shaving plane (SP), in use.

It is to be noted that the terms “leading longitudinal member 24” and “trailing longitudinal member 25” are used to denote specific locations on the razor cartridge 20, and do not imply or require the absence or presence of a particular feature. For example, a guard member 23 may in one example be located at the side comprising the “leading longitudinal member 24”, and in another example a trimming blade 53 may be located at the side comprising the “trailing longitudinal member 25” in another example, but it is not essential that these sides of the razor cartridge 20 comprise such features.

The guard member 23, in examples, comprises an elastomeric member (not shown in FIG. 4). In examples, the elastomeric layer comprises one or more fins extending longitudinally in parallel to the guard member 23 and substantially perpendicularly to the shaving direction. One purpose of such an elastomeric layer is, for example, to tension the skin prior to cutting.

The razor cartridge 20 may, in embodiments, further comprise a cap member 29 at, or near to, the trailing longitudinal side 25 but this is not illustrated in the embodiment of FIG. 4 as an aid to clarity.

The razor cartridge 20 further comprises a group of cutting members 28a-d accommodated in a cutting member receiving section 31 of the frame 21. The group of cutting members 28a-d comprises a plurality of longitudinal cutting members 28a-d. In embodiments, each of the longitudinal cutting members 28a-d comprises a blade 33a-d having a cutting edge 30a-d. The group of cutting members 28a-d is disposed in the frame 21 longitudinally and transverse to the shaving direction S such that in use, the blades 33a-d of the cutting members 28a-d contact the shaving plane SP and cut hair present on the shaving plane SP as the razor cartridge 20 is moved across the shaving plane SP in the shaving direction S.

The razor cartridge 20 is provided with four cutting members 28a-d. In embodiments, the razor cartridge 20 can be provided with at least one cutting member 28. In particular, the razor cartridge 20 can be provided with one cutting member, two cutting members, three cutting members, four cutting members, five cutting members, six cutting members, seven cutting members or more cutting members.

The group of cutting members 28a-d defines a plurality of substantially parallel inter-blade spans. In conventional razor cartridges having blades above the support, with three or more blades, each inter-blade span is measured to be constant in a range of about 1.05 mm to 1.5 mm. The number of inter-blade spans is one fewer than the number of cutting members. It is to be noted that the skin-contacting surface 10 comprising the variable friction resistance element 11 might also be arranged in the inter-blade spans. In embodiments and as mentioned above, the variable friction resistance element 11 is disposed at the leading longitudinal member 24, and/or the trailing longitudinal member 25, and/or at the at least one shaving direction frame member 35. Additionally or alternatively, the variable friction resistance element 11 can be disposed adjacent to the cutting members 28a-d and extending in shaving direction S and perpendicular direction P. The variable friction resistance element 11 can also be provided on the back of the cutting members 28a-d and/or between the cutting members 28a-d and the leading and trailing longitudinal members 24, 25, and/or, in case a plurality of cutting members 28a-d is provided, between the cutting members 28a-d, facing the skin surface K.

The frame 21 further comprises a first retainer 26 and a second retainer 27 configured to hold the cutting members 28a-d within razor cartridge 20 housing. The frame 21 further comprises first 16 and second 18 side portions. When the razor cartridge 20 is assembled, the first and second side portions 16, 18 are configured to confine the longitudinal ends of the guard member 23, a cap member (if present, not shown in FIG. 4) and the group of cutting members 28a-d. The first side retainer 26 and second retainer 27 may comprise, for example, plastic, an elastomer, or a metal material and furthermore may be of a different shape to that illustrated.

In examples, the cutting members 28a-d comprised in the group of cutting members 28a-d are disposed in the razor cartridge 20 such that two cutting edges 30a,b comprised, respectively, on the two foremost, i.e. nearest to the leading longitudinal member 24 of the razor cartridge 20, cutting members 28a,b of the group of cutting members 28a-d define a leading inter-blade span that is closest to the leading longitudinal side 24 of the razor cartridge 20 and that is greater than a trailing inter-blade span defined between the two cutting edges that are closest to the trailing longitudinal side 25 of the razor cartridge.

The razor cartridge 20 of FIG. 4 comprises four resilient fingers 38a, 38b, 38c, 38d under the first retainer 26. The razor cartridge 20 comprises four resilient fingers under the second retainer 27 that are in transverse corresponding alignment with the four resilient fingers 38a, 38b, 38c, 38d under the first retainer 26.

In total, the eight resilient fingers each exert a bias force against respective cutting members 28a-d of the group of cutting members 28a-d in the direction of the shaving plane SP, such that the cutting members 28a-d of the group of cutting members 28a-d are in a rest position, when the razor cartridge 20 is assembled. In the rest position, the cutting edges 30 of the blades 33 of the cutting members 28a-d, bear against corresponding stop portions at each lateral end of the blades 33 near the first 26 and second 27 retainers, for example. In examples, the stop portions may be the first 26 and second 27 retainer.

Accordingly, the rest position of the cutting members 28a-d is well defined, enabling a high shaving precision. Of course, the illustrated biasing arrangement has many variations. For example, a further plurality of resilient fingers may be provided on one or more of the shaving direction frame member s 35. In a simplified razor cartridge design (such as for low cost, disposable razors), the resilient fingers may be omitted. A skilled person will appreciate that the number of resilient fingers 38 to be provided is related to the number of cutting members 28a-d in the group of cutting members 28a-d, and that fewer or more than eight resilient fingers 38 can be provided.

In examples, each cutting member 28a-d in the group of cutting members 28a-d comprise a longitudinal blade support 32. A longitudinal blade 33 is mounted on the blade support 32. The cutting edge 30 of a blade 28a-d is oriented forward in the direction of shaving S. The blade support 32 of a blade 28a-d is an elongated, bent piece of rigid material. In examples, the blade support 32 is a metal such as austenitic stainless steel.

Each cutting member 28a-d in the group of cutting members 28a-d is, in examples, resiliently mounted in a blade receiving section 31 of the razor cartridge 20. The blade receiving section 31 comprises a longitudinal space in the razor cartridge 20 that is sized to accommodate the group of cutting members 28a-d. At least one cutting member 28a of the group of cutting members 28a-d, up to all cutting members in the group of cutting members 28a-d may be resiliently mounted in the blade receiving section 31. In the illustrated example of FIG. 4, the transverse inner sides of frame 21 comprise a plurality of holding slots 34. Each holding slot 34 on the transverse inner sides is configured to accept and retain an end of one side of a blade support 32 of a cutting member 28a of the group of cutting members 28a-d so that the cutting members 28a-d of the group of cutting members 28a-d are held in the blade receiving section 31 with a substantially parallel inter-blade span in the transverse direction (−x to x). Therefore, as many holding slots 34 are provided in each transverse inner side of frame 21 as there are blades.

Between the cutting member receiving section 31 and the handle (in a part adjacent to a handle connection, for example) there are, in examples, provided one or more shaving direction frame members 35 that are integrally formed with the frame 21. The shaving direction frame members 35 comprises a plurality of cutting member guides 36a-d provided as a plurality of protuberances aligned with the holding slots 34a-d on the transverse inner sides of the frame 21. The cutting member guides 36a-d function to regulate the parallel inter-blade span.

The cutting member guide 36 is provided on a portion of the shaving direction frame member 35 as a protrusion. For example, the cutting member guide 36 is provided as an injection-molded protrusion of the shaving direction frame member 35. For example, the cutting member guide 36 is integrally formed with the shaving direction frame member 35. In examples, each cutting member guide 36 of the plurality of cutting member guides 36a-d is aligned on a common axis of the at least one shaving direction frame member 35. In examples, each cutting member guide of the plurality of cutting member guides is aligned on a central axis of the at least one shaving direction frame member 35. In examples, at least one cutting member guide 36 is aligned away from a common axis or central axis 35 of the at least one shaving direction frame member 35.

In embodiments, a longitudinal skincare element 50 is held on an example longitudinal trailing assembly 49. In examples, the alternative razor cartridge 20 comprises a trimming blade assembly 53. A skilled person will appreciate that the example longitudinal trailing assembly 49 may be omitted without loss of generality. The cutting members 28a-d comprise blade supports 32a-32d and their blades 33 are positioned in-between the cutting member guides 36a-36d.

In embodiments, the razor cartridge 20 is designed to accommodate two, three, four, five, six, or more cutting members 28a-d comprising blade supports 32a-32d (and their blades).

In embodiments, the blade supports 32a-32d each comprise blades facing away from the shaving plane (SP). In other words, the blades may be mounted “underneath the blade support”. The phrase “underneath the blade support” for the purposes of this specification means a side of a blade support of a razor cartridge that is furthest from a shaving plane (SP) (skin) of a user when the razor cartridge is in use.

In embodiments, the blade guides 36a-36d are configured to support “bent blades” having a radiused portion in which the cutting edge is integral with (formed from the same piece of metal) as the blade support, as known to a skilled person. Blade guides 36a-36d configured to support “bent blades” may, for example, comprise a curved upper portion configured to support or accommodate the radius portion of the “bent blade”, for example.

As described above, the razor cartridge 20 includes at least one cutting member 28a-d, which has a cutting edge 30a-d that lies in the shaving plane (SP). The razor cartridge 20 comprises the frame 21 that has the leading longitudinal member 24, the trailing longitudinal member 25, and the at least one shaving direction frame member 35 joining the leading longitudinal member 24 and the trailing longitudinal member 25, in the shaving direction S of the razor cartridge 20. The frame 21 comprises the skin-contacting surface 10 that faces and contacts the user's skin surface K. As stated above, the skin-contacting surface 10 on the frame 21 defines the plane SCP, in particular the skin contacting plane SCP.

In embodiments, when moving the razor cartridge 20 in the perpendicular direction P and/or the oblique direction O, the frictional resistance is increased compared to moving the razor cartridge 20 in the shaving direction S. The variable friction resistance element 11 is adapted to contact the skin surface K and the variable friction resistance element 11 is in an engaged state. In particular, the variable friction resistance element 11 can be transitioned to an engaged state. In the engaged state, the frictional resistance of the variable friction resistance element 11 can be increased and the variable friction resistance element 11 can be tensioned against the skin surface K. Due to the perpendicular motion and/or oblique motion and the resulting increased friction contact area A_{P} and/or A_{O} with the skin surface K, the variable friction resistance element can be tensioned against the skin surface K in multiple directions. As described above, an increased friction contact area A_{P} and/or A_{O} with the skin surface K leads to an increased friction coefficient μ_{P} and/or μ_{O} and as a result to an increased frictional resistance, compared to a movement in shaving direction S. As a result, the variable friction resistance element 11 inhibits a movement of the razor cartridge 20 over the skin surface K, because an increased friction resistance between variable friction resistance element 11 and the skin surface K occurs.

In embodiments, when moving the razor cartridge 20 in the shaving direction S, the frictional resistance is reduced compared to moving the razor cartridge 20 in the perpendicular direction P and/or in the oblique direction O. When moving the razor cartridge 20 in the shaving direction S, the variable friction resistance element 11 is in a relaxed state. In particular, the razor cartridge 20 begins its movement from the initial state as described above. In the initial state and when moving the razor cartridge 20 in shaving direction S, the frictional resistance is reduced compared to a movement in perpendicular direction P and/or oblique direction O. In the relaxed state, the variable friction resistance element 11 slides over the skin surface K and the variable friction resistance element 11 is configured to reduce a friction contact area A_{S} with the skin surface K. In particular, a reduced friction contact area A_{S} with the skin surface K leads to a reduced friction coefficient μ_{S} and as a result to a reduced frictional resistance as mentioned above, wherein the variable friction resistance element 11 promotes a movement of the razor cartridge 20 over the skin surface K.

In embodiments, in the engaged state a shape change is induced in the variable friction resistance element 11. For instance, the shape change can tension the variable friction resistance element 11 against the skin surface K in multiple directions. The shape change in the variable friction resistance element 11 leads to an increased friction contact area with the skin surface K. The increased friction contact area with the skin surface K improves the tensioning of the variable friction resistance element 11 against the skin surface K.

In embodiments, the variable friction resistance element 11 is in the form of a strip. The skin-contacting surface 10 includes the components of the razor cartridge 20 facing and contacting the skin surface K and comprises the variable friction resistance element 11. The variable friction resistance element 11 can have any shape and size that is suitable to be provided on the razor cartridge 20 in the skin-contacting surface 10, for example a tape, line, strip, sphere or cuboid. The skin-contacting surface 10 can be at the leading longitudinal member 24, the trailing longitudinal member 25 and at the at least one shaving direction frame member 35 facing the skin surface K.

In embodiments, the variable friction resistance element 11 comprises a plurality of structured protrusions 12. The plurality of structured protrusions 12 is extending from the razor cartridge along a direction Z which is perpendicular to the skin-contacting plane SCP defined by the skin-contacting surface 10, perpendicular to shaving direction S and perpendicular direction P. The structured protrusions 12 can be movable. In the engaged state, the structured protrusions 12 can change its shape compared to the relaxed state, such that the contact area to the skin surface K is increased. Thereby, the friction coefficient and in turn the frictional resistance are increased. The structured protrusions 12 can have any suitable shape and form. The structured protrusions 12 can be arranged in one or more rows, in individual separate groups, in different heights and widths, symmetrically, asymmetrically, axis-symmetrically or point-symmetrically to the respective directions S, P of the razor cartridge 20 in the skin-contacting surface 10. However, the structured protrusions 12 are adapted such that the contact area with the skin surface K increased by a movement in perpendicular direction P and/or oblique direction O, compared to a movement in shaving direction P.

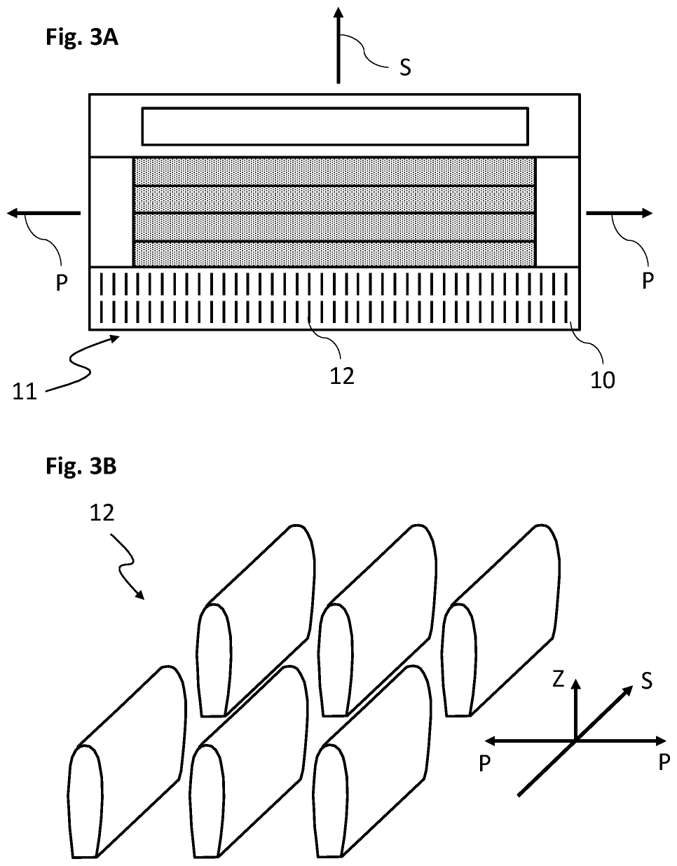

In embodiments, as shown in FIGS. 3A and 3B, the plurality of structured protrusions 12 has gripping elements. The structured protrusions 12 can be rotatable in perpendicular direction P and/or at least partly in oblique direction O, but not in shaving direction S, as shown, for example, in FIG. 3B. The gripping elements, in particular gripping hairs, have a shape and material properties that enable a tensioning of the variable friction resistance element 11 against the skin surface K due to a movement in perpendicular direction P and/or oblique direction O. The gripping elements, in particular gripping hairs, increase the contact area to the skin surface K by a motion in perpendicular direction P and/or oblique direction O. The gripping hairs have properties such as density and length that are optimized in structure in order to maximize the grip against the microstructured topology of the skin.

In embodiments, the plurality of structured protrusions 12 has a concertina patterning of ridges, as shown in FIGS. 1A to 1C and FIG. 9, 10. The ridges have laterally fixed points 16 that are flexible in the shaving direction S and have raised points 15 that are flexible in the perpendicular direction P. The raised points 15 and the fixed points 16 are connected by connecting struts 17. In the relaxed state, the concertina patterning of ridges is folded, wherein raised points 16 and fixed points 15 are in an initial “folded” state, as shown in FIGS. 1A and 1C on the left. During the transition from the relaxed state to the engaged state of the variable friction resistance element 11, the concertina patterning of ridges is straightened in the skin-contacting surface 10. In the engaged state, the concertina patterning of ridges is straightened, wherein, compared to the initial “folded” state, the raised points 15 have been moved in perpendicular direction P and wherein the fixed points 16 have been moved in shaving direction S, i.e. forward and backward. Thus, the concertina patterning of ridges, and as a result the variable friction resistance element 11, are tensioned against the skin surface K in multiple directions, wherein the frictional resistance is increased. In particular, the multiple directions refer to the perpendicular direction P and oblique directions O for different angle values of a. Therefore, the concertina pattering of ridges can have a shape and structure that is adapted for the perpendicular direction P and various oblique directions O, wherein proper tensioning to the skin surface K can be achieved.

As shown in FIG. 1A, the razor cartridge 20 defines a symmetry axis y extending in shaving direction S and through the geometrical center of the razor cartridge 20 in the skin-contacting surface 10, and an axis x, extending in perpendicular direction P and through the geometrical center of the razor cartridge 20 in the skin-contacting surface 10. Axis x is perpendicular to axis y. In embodiments, and as shown in FIGS. 1A and 1B and 10, the concertina patterning of ridges is disposed on the razor cartridge 20 axiymmetrically with respect to the symmetry axis y. On the right side of the symmetry axis y shown in FIG. 1A, the laterally fixed points 16 are arranged on the outer side in perpendicular direction P of every ridge with respect to the symmetry axis y. The raised points 15 are on the inner side of the ridges with respect to symmetry axis y. The ridges can be structured in a row, extending from symmetry axis y of the razor cartridge 20 to the outer edge of the cartridge 20 in perpendicular direction P. Additionally or alternatively, the ridges can be arranged in separate groups or in any other configuration. In embodiments, at least some of the ridges can be tilted in order to provide better tensioning abilities by a movement in oblique direction. On the left side of the symmetry axis y with respect to FIG. 1A, the ridges are mirrored compared to the right side as explained above. In particular, in case that a movement in perpendicular direction P occurs, i.e. in the tensioned state, the ridges can be expanded, resulting in an increased contact area with respect to the skin surface K in multiple directions. Thereby, the frictional resistance with the skin surface K increases. This inhibits the movement of the razor cartridge 20 in perpendicular direction P and/or oblique direction O. In embodiments, on the respective outer surfaces of the ridges, in particular the outer surface of the connecting struts 17, can be equipped with hairs, in particular microstructure hairs, that improve the contact area to the skin surface K.

As described above, the razor cartridge 20 defines the direction Z that is perpendicular to the skin-contacting plane SCP defined by the skin-contacting surface 10, the shaving direction S and the perpendicular direction P, as shown in FIG. 3B.

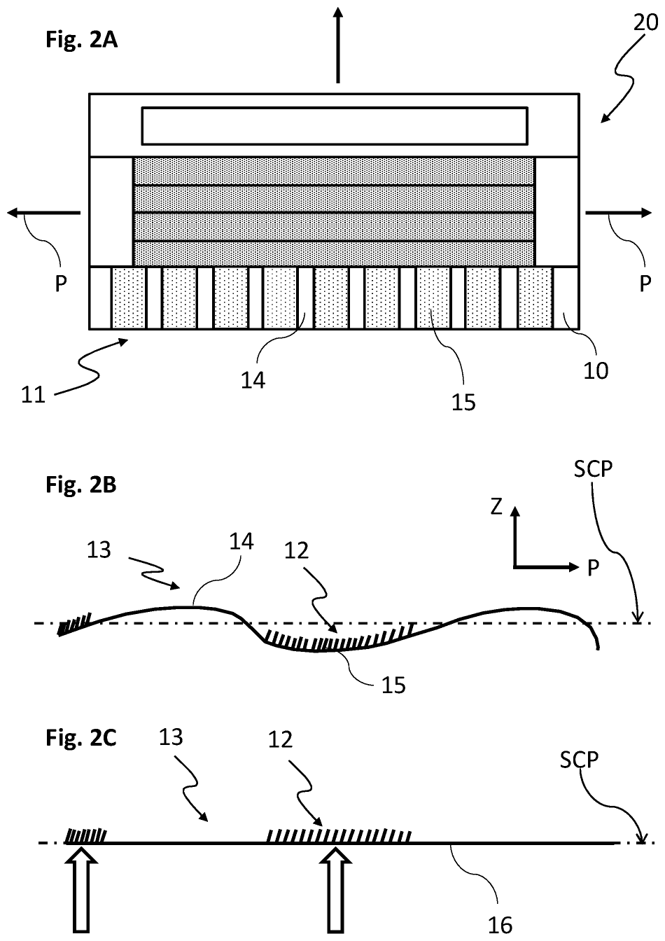

In embodiments, the variable friction resistance element 11 comprises a corrugated shape 13 in the plane SCP. As shown in FIGS. 2A and 2B, the corrugated shape 13 can have peaks 14 with a smooth surface and depressions 15 provided with structured protrusions 12. As a result, this arrangement comprises a depth profiling. The variable friction resistance element 11 can comprise elastic material that changes its behavior due to a motion direction. In the relaxed state, the peaks 14 with the smooth surface contact the skin surface K and the structured protrusions 12 are distanced from the skin surface K. In the engaged state, the corrugated shape 13 is transitioned to a flat shape, wherein the smooth surface and the structured protrusions 12 contact the skin surface K, resulting in an increased frictional resistance of the variable friction resistance element 11. In other words, by a movement in shaving direction S, the variable friction resistance element 11 having the corrugated shape 13 is in the relaxed state and slides over the skin surface. In particular, only the peaks 14 with the smooth surface contact the skin, but not the depressions 15 having the structured protrusions. In case a movement occurs in perpendicular direction P and/or oblique direction O, the variable friction resistance element 11 is in the engaged state and the corrugated shape 13 transitions to a flat shape 16 as shown in FIG. 2C, such that the structured protrusions 12 contact the skin surface K. Thereby, the structured protrusions can be tensioned against the skin surface wherein the frictional resistance increases. As a result, the movement of the razor cartridge 20 can be inhibited.

In embodiments, the variable friction resistance element 11 comprises a shape change component. The shape change component is adapted to provoke a shape change in the variable friction resistance element 11. In particular, the shape change component can provoke a shape change of the plurality of structured protrusions 12, wherein the plurality of structured protrusions 12 is shifted into a tensioned state. In embodiments, the shape change component is adapted to actuate the plurality of structured protrusions. The shape change component can be associated with properties that define the force and distance of travel required to engage the variable friction resistance element 11. These properties can be controlled such that the grip, in particular increased contact area and friction coefficient, engages before any skin cut occurs but is not activated in scenarios wherein no cut can occurs, for example by a movement in shaving direction S or in case the razor cartridge 20 is not applied on the skin surface K. Controlled properties can be the geometry of the components of the structured protrusions 12, or material stiffness. Consequently, the shape change component leads to fast engagement of the variable friction resistance element 11 with the skin surface K, having an increased friction function. A motion in perpendicular direction P and/or oblique direction O of the razor cartridge can thereby be prevented. The travel distance or required friction conditions are controlled such that the grip function only occurs in case of necessity. In embodiments, the shape change component provides the ability to rapidly switch the variable friction resistance element 11 from a relaxed to an engaged state using bi-stable structures, wherein a greater stopping force is enabled with a smaller initiating friction force.

In embodiments, the shape change component can be activated when moving the razor cartridge 20 in the perpendicular direction P and/or oblique direction O. The shape change component can include an active actuator, in particular wherein the active actuator actuates the plurality of structured protrusions 12. The shape change component can be activated by a sensor that is disposed in the razor cartridge 20. Additionally or alternatively, the sensor can be disposed in the razor handle. In embodiments, the sensor is configured to detect a movement of the razor cartridge 20 in perpendicular direction P and/or oblique direction O. If the sensor detects a movement in perpendicular direction P and/or oblique direction O, the sensor transmits a signal to the shape change component. Subsequent to receiving the signal, the shape change component actuates the structured protrusions 12. Additionally or alternatively, the shape change component can actuate the structured protrusions 12 based on a shape change induced on the plurality of structured protrusions 12 when moving the razor cartridge 20 in the perpendicular direction P and/or oblique direction O.

In embodiments, the razor cartridge 20 comprises a bi-stable mechanism. The bi-stable mechanism can be included in the plurality of structured protrusions 12. When moving the variable friction resistance element 11 in perpendicular direction P and/or oblique direction O, the bi-stable mechanism can induce a shape change in the plurality of structured protrusions 12. In particular, the plurality of structured protrusions 12 can be shifted into a shape changed state therein, in particular a tensioned state. The plurality of structured protrusions 12 can be designed such that it has a bi-stable state. A small amount of perpendicular force, generated by a movement in perpendicular direction P and/or oblique direction O, enables a rapid shift into a second, e.g. energetically, state causing significant tensioning against the skin surface K. Thereby, a much greater force and movement amplitude can be achieved than the force/motion initiated by the shape change. With regard to FIGS. 1A to 1C, the plurality of structured protrusions 12, e.g. in the form of concertina patterning of ridges, is energetically preferred by the tensions in the connecting strut material, enabling a faster and more dramatic shift.

In embodiments, the variable friction resistance element 11 comprises a de-tensioning device. The de-tensioning device can be adapted to release the tensioned state applied in the plurality of structured protrusions 12, for example the tensioned state induced by means of the bi-stable mechanism and/or the shape-change component. The de-tensioning device releases the tension in the variable friction resistance element 11, in particular the structured protrusions 12, by applying a mechanical force on the de-tensioning device. In particular, the de-tensioning device is activated by a mechanical force on the de-tensioning device. In embodiments, the de-tensioning device comprises a button 260 that is arranged on a razor handle 200 and/or the razor cartridge 20. The mechanical force applied on the de-tensioning device is generated by pushing the button. The button applies a lifting force to the tensioning structure or is provided in a way which is counter to the frictional force application. Thereby, the variable friction resistance element 11 is returned to a relaxed state, wherein the tension is released. By pressing the button, the variable friction resistance mechanism element 11 is disengaged with respect to the skin surface K. In embodiments, an electrically powered actuator receives a signal from a user, e.g. a button press, and applies mechanical force on the de-tensioning device, wherein the variable friction resistance element 11 is disengaged with respect to the skin surface K. In embodiments, a signal can be generated by a sensor applied in the razor cartridge, when the razor cartridge is moved back from the engaged state to the initial state. This signal can be transmitted to the de-tensioning mechanism, wherein the de-tensioning mechanism is activated. As follows, the variable friction resistance element 11 has a similar behavior as a gecko-feet with regard to engaging with surfaces like the skin surface K.

According to a second aspect, a kit of parts is provided that comprises a razor cartridge holder comprising a plurality of razor cartridges 20 as described above and in examples a razor handle 200. The kit of parts can comprise one or more razor cartridges 20. In embodiments, the kit of parts can comprise at least three razor cartridges.

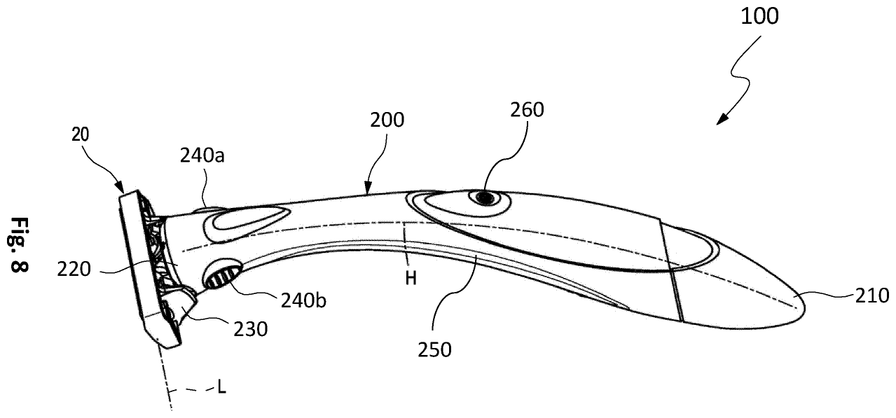

FIGS. 7 and 8 are perspective views of a razor 100 according to a third aspect. The razor 100 comprises a razor handle 200 and a razor cartridge 20 as described hereinabove. The razor cartridge 20 is coupled to the razor handle 200. It should be noted that the razor 100 comprising the razor handle 200, the razor cartridge 20 and the variable friction resistance element 11 can be any wet shaving razor known in the state of the art including shaving blades, wherein hairs are removed due to a movement, in particular due to shaving strokes in shaving direction (S), by a user on the skin surface K. Alternatively, the razor 100 comprising the razor handle 200, the razor head 20 and variable friction resistance element 11 can be any electrically operated razor or dry razor as known in the state of the art, wherein the razor 100 comprises a rotating or oscillating blade, powered by an electric module, e.g. a battery.

The razor handle 200 extends in a handle direction H between a proximal portion 210 and a distal portion 220 of the razor handle 200. The razor cartridge 20 is mounted at the distal portion 220 of the razor handle 200. The mounting of the razor cartridge 20 to the distal portion 220 of the razor handle 200 in the illustration is, in embodiments, via a coupling 230, in an example, a pivotable coupling, enabling a frame of reference of the razor handle 200 to vary relative to a frame of reference of the razor head 20. This enables the angle of the razor head 20 against the skin of a user to vary and adapt to changes during use.

In particular, the razor cartridge 20 pivots relative to the razor handle 200 about the longitudinal axis L of the razor cartridge 20, in use. The pivoting enables the user to adapt to contours of the body, for example. The longitudinal axis L of the razor cartridge 20 is substantially perpendicular to the shaving direction S along the razor handle 200. Examples of a connection mechanism for connecting the razor cartridge 20 to the handle 200 is discussed in WO2006/027018 A1. An example is a razor cartridge 20 that may pivot relative to a second pivot axis, i.e. a rocking axis, substantially perpendicular to axis L.

In embodiments, the razor cartridge 20 is either releasably attached to the razor handle 200 via a pivotable or non-pivotable coupling 230, integrally formed with the razor handle 200 via a non-pivotable coupling 230, or integrally formed with the razor handle 200 via a pivotable coupling 230. In examples, the pivotable coupling 230 may further comprise, or be replaced by, a release mechanism 240a, 240b, enabling rapid release of an exhausted razor cartridge 20 from the razor handle 200.

In embodiments, the razor handle 200 and the support of the razor cartridge 20 are integrally formed with a pivotable coupling (not illustrated) such as a resilient plastic spring member.

In embodiments, the frame 21 of the razor cartridge 20 is connectable to the razor handle 200 of the razor 100 either integrally, or by a connection mechanism such as the pivotable coupling 230 or by an interconnecting member (not shown). Although not illustrated, the pivotable coupling 230, in embodiments, may be provided on the side of the razor cartridge 20 configured to connect to a pivotable handle 200. The pivotable coupling 230, in an example, comprises two or more shell bearings configured to connect to a pivotable coupling of the razor handle 200.

In embodiments, the razor handle 200 is provided with a handle grip 250 formed of a rubber, or rubber-like material to improve gripping friction.

According to a fourth aspect, a method for avoiding skin irritation during a shaving operation by a user with a razor 100 is provided. The method comprises the steps of
a) providing a razor 100 having a razor cartridge 20 with a skin-contacting surface 10 that includes a variable friction resistance element 11 having a frictional resistance which is dependent on a motion direction of the razor 100,
b) performing a shaving operation with the razor 100 wherein the skin-contacting surface 10 contacts a user's skin surface K, wherein the variable friction resistance element 11 inhibits the motion of the razor cartridge 20 in a direction perpendicular P to a shaving direction S.

In embodiments, the method further comprises that the variable friction resistance element 11 is adapted to increase the frictional resistance of the variable friction resistance element 11 due to a motion in the perpendicular direction P. Additionally, when moving the razor cartridge 20 in the perpendicular direction P, the variable friction resistance element 20 is in an engaged state, in particular wherein the variable friction resistance element 11 transitions to an engaged state.

In embodiments, the method further comprises that in the engaged state, a shape change is induced in the variable friction resistance element 11, wherein a friction contact area of the variable friction resistance element 11 with the skin surface K is increased. Additionally, the variable friction resistance element 11 can comprise structured protrusions 12 that are adaptable to increase a friction contact area with the skin surface K.

Although the present disclosure has been described above and is defined in the attached claims, it should be understood that the disclosure may alternatively be defined in accordance with the following embodiments:
1. A razor cartridge, comprising:
   a skin-contacting surface configured to contact a user's skin surface (K) during a shaving operation,
   characterized in that the skin-contacting surface includes a variable friction resistance element having a frictional resistance which is dependent on a motion direction of the razor cartridge over the user's skin surface (K).
2. The razor cartridge according to embodiment 1, wherein the razor cartridge defines a shaving direction (S) and a perpendicular direction (P).
3. The razor cartridge according to embodiment 2, wherein the razor cartridge defines an oblique direction (O) that is defined as a direction combined of perpendicular direction (P) and shaving direction (S), in particular at an angle α with respect to the perpendicular direction (P).
4. The razor cartridge according to embodiment 2 or embodiment 3, wherein the frictional resistance when moving the razor cartridge in the perpendicular direction (P) is higher, specifically at least two times higher, more specifically at least three times higher, than when moving the razor cartridge in the shaving direction (S).
5. The razor cartridge according to embodiment 3 or embodiment 4, wherein the frictional resistance when moving the razor cartridge in the oblique direction (O) is higher than when moving the razor cartridge in the shaving direction (S).
6. The razor cartridge according to any one of embodiments 2 to 5, wherein when moving the razor cartridge in the shaving direction (S), the frictional resistance is determined by a friction coefficient μ_{S}≤0.35, specifically μ_{S}≤0.2, and more specifically μ_{S}≤0.15, and a normal force F_{SN}.
7. The razor cartridge according to any one of embodiments 2 to 6, wherein when moving the cartridge in the perpendicular direction (P), the frictional resistance is determined by a friction coefficient μ_{P}≥0.15, specifically μ_{P}≥0.2, and more specifically μ_{P}≥0.35, and a normal force F_{PN}.
8. The razor cartridge according to any one of embodiments 2 to 7, wherein the variable friction resistance element is adapted to inhibit a motion in the perpendicular direction (P).
9. The razor cartridge according to any one of embodiments 2 to 8, wherein the razor cartridge includes at least one cutting member, which has a cutting edge that lies in a shaving plane (SP).
10. The razor cartridge according to any one of embodiments 2 to 9, wherein the razor cartridge comprises a frame that has a leading longitudinal member, a trailing longitudinal member, and at least one shaving direction frame member (35) joining the leading longitudinal member and the trailing longitudinal member, in the shaving direction (S) of the razor cartridge, wherein the frame comprises the skin-contacting surface.
11. The razor cartridge according to embodiment 10, wherein the at least one cutting member (28a-d) is disposed between the leading longitudinal member and the trailing longitudinal member and wherein the cutting edge (30a-d) is disposed parallel to the leading longitudinal member and the trailing longitudinal member.
12. The razor cartridge according to any one of embodiments 2 to 11, wherein when moving the razor cartridge in the perpendicular direction (P), the frictional resistance is increased compared to moving the razor cartridge in the shaving direction (S).
13. The razor cartridge according to any one of embodiments 2 to 12, wherein when moving the razor cartridge in the perpendicular direction (P), the variable friction resistance element is in an engaged state, in particular wherein the variable friction resistance element is transitioned to an engaged state.
14. The razor cartridge according to any one of embodiments 2 to 13, wherein when moving the razor cartridge in the shaving direction (S), the frictional resistance is reduced compared to moving the razor cartridge in the perpendicular direction (P).
15. The razor cartridge according to any one of embodiments 2 to 14, wherein when moving the razor cartridge in the shaving direction (S), the variable friction resistance element is in a relaxed state.
16. The razor cartridge according to any one of embodiments 13 to 15, wherein in the engaged state, the variable friction resistance element is configured to increase a friction contact area with the skin surface (K).
17. The razor cartridge according to any one of embodiments 13 to 16, wherein in the engaged state, the variable friction resistance element is tensioned against the skin surface (K).
18. The razor cartridge according to any one of embodiments 15 to 17, wherein in the relaxed state, the variable friction resistance element is configured to reduce a friction contact area with the skin surface (K).
19. The razor cartridge according to any one of embodiments 15 to 18, wherein in the relaxed state, the variable friction resistance element slides over the skin surface (K).
20. The razor cartridge according to any one of embodiments 13 to 19, wherein in the engaged state, a shape change is induced in the variable friction resistance element.
21. The razor cartridge according to any one of the preceding embodiments, wherein the variable friction resistance element is in the form of a strip.
22. The razor cartridge according to any one of embodiments 10 to 21, wherein the variable friction resistance element is disposed at the trailing longitudinal member and/or the leading longitudinal member.
23. The razor cartridge according to any one of the preceding embodiments, wherein the variable friction resistance element comprises a plurality of structured protrusions, in particular wherein the plurality of structured protrusions is extending from the variable friction resistance element.
24. The razor cartridge according to embodiment 23, wherein the plurality of structured protrusions has gripping elements.
25. The razor cartridge according to embodiment 23, wherein the plurality of structured protrusions has a concertina patterning of ridges.
26. The razor cartridge according to any one of embodiments 2 to 25, wherein the razor cartridge defines a direction (Z) that is perpendicular to a plane (SCP) defined by the shaving direction (S) and the perpendicular direction (P) in the skin-contacting surface
27. The razor cartridge according to embodiment 26, wherein the variable friction resistance element comprises a corrugated shape in the skin-contacting plane (SCP).
28. The razor cartridge according to embodiment 27, wherein the corrugated shape has peaks with a smooth surface and depressions with the structured protrusions.
29. The razor cartridge according to embodiment 27 or embodiment 28, wherein in the engaged state, the corrugated shape transitions to a flat shape.
30. The razor cartridge according to any one of the preceding embodiments, wherein the variable friction resistance element comprises a shape change component.
31. The razor cartridge according to embodiment 30, wherein the shape change component is adapted to provoke a shape change in the variable friction resistance element, in particular a shape-change of the plurality of structured protrusions, wherein the plurality of structured protrusions is shifted into a tensioned state.
32. The razor cartridge according to embodiment 30 or embodiment 31, wherein the shape change component is adapted to actuate the plurality of structured protrusions.
33. The razor cartridge according to any one of embodiments 30 to 32, wherein the shape change component is activated when moving the cartridge in the perpendicular direction (P).
34. The razor cartridge according to any one of embodiments 30 to 33, wherein the shape change component includes an active actuator, in particular wherein the active actuator actuates the plurality of structured protrusions.
35. The razor cartridge according to any one of embodiments 30 to 34, wherein the shape change component is activated by a sensor disposed in the razor cartridge.
36. The razor cartridge according to embodiment 35, wherein the sensor is configured to detect a movement of the razor cartridge in the perpendicular direction (P).
37. The razor cartridge according to embodiment 35 or embodiment 36, wherein the sensor is configured to detect a movement of the razor cartridge in the perpendicular direction (P).
38. The razor cartridge according to any one of embodiments 30 to 37, wherein the shape change component actuates the structured protrusions based on a shape change induced on the plurality of structured protrusions when moving the razor cartridge in the perpendicular direction (P).
39. The razor cartridge according to any one of the preceding embodiments, wherein the variable friction resistance element comprises a bi-stable mechanism.
40. The razor cartridge according to embodiment 39, wherein the bi-stable mechanism is included in the plurality of structured protrusions.
41. The razor cartridge according to embodiment 39 or embodiment 40, wherein when moving the variable friction resistance element in the perpendicular direction (P), the bi-stable mechanism induces a shape change in the plurality of structured protrusions, in particular wherein the plurality of structured protrusions is shifted into a shape-changed state, in particular a tensioned state.
42. The razor cartridge according to any one of the preceding embodiments, wherein the variable friction resistance element comprises a de-tensioning device.
43. The razor cartridge according to embodiment 42, wherein the de-tensioning device is adapted to release the tensioned state applied in the plurality of structured protrusions.
44. The razor cartridge according to embodiment 42 or embodiment 43, wherein the de-tensioning device is activated by a mechanical force applied on the de-tensioning device.
45. The razor cartridge according to embodiment 44, wherein the mechanical force applied on the de-tensioning device is generated by a button.
46. The razor cartridge according to embodiment 44, wherein an electrically powered actuator applies the mechanical force on the de-tensioning device.
47. A kit of parts, comprising:
   a razor cartridge holder comprising a plurality of razor cartridges according to any one of embodiments 1 to 46, and a razor handle (200).
48. A razor (100) comprising:
   a razor handle (200), and
   a razor cartridge according to any one of embodiments 1 to 46, wherein the razor cartridge is coupled to the razor handle (200).
49. The razor according to embodiment 48, wherein the razor cartridge is either releasably attached to the razor handle (200) via a pivotable or non-pivotable coupling (230), integrally formed with the razor handle (200) via a non-pivotable coupling (230), or integrally formed with the razor handle (200) via a pivotable coupling (230).
50. A method for avoiding skin irritation during a shaving operation by a user with a razor (100), comprising the steps of:
   a) providing a razor (100) having a razor cartridge with a skin-contacting surface that includes a variable friction resistance element having a frictional resistance which is dependent on a motion direction of the razor (100),
   b) performing a shaving operation with the razor (100) wherein the skin-contacting surface contacts a user's skin surface (K), wherein the variable friction resistance element inhibits the motion of the razor cartridge in a direction perpendicular (P) to a shaving direction (S).
51. The method according to embodiment 50, wherein the variable friction resistance element is adapted to increase the frictional resistance of the variable friction resistance element due to a motion in the perpendicular direction (P).
52. The method according to embodiment 50 or embodiment 51, wherein when moving the razor cartridge in the perpendicular direction (P), the variable friction resistance element is in an engaged state, in particular wherein the variable friction resistance element transitions to an engaged state.
53. The method according to embodiment 52, wherein in the engaged state, a shape change is induced in the variable friction resistance element, wherein a friction contact area of the variable friction resistance element with the skin surface (K) is increased.
54. The method according to any one of embodiments 50 to 53, wherein the variable friction resistance element comprises structured protrusions that are adaptable to increase a friction contact area with the skin surface (K).

REFERENCE NUMERALS

| H | razor handle direction |
|---|---|
| S | shaving direction |
| P | perpendicular direction |
| O | oblique direction |
| SP | shaving plane |
| SCP | skin-contacting plane |
| L | longitudinal direction |
| K | skin or skin surface |
| F_{SN} | normal force in shaving direction |
| F_{PN} | normal force in perpendicular |
| | direction |
| F_{ON} | normal force in oblique direction |
| μ_{S} | friction coefficient in shaving |
| | direction |
| μ_{P} | friction coefficient in perpendicular |
| | direction |
| | friction coefficient in oblique |
| | direction |
| A_{S} | friction contact area in shaving |
| | direction |
| A_{P} | friction contact area in perpendicular |
| | direction |
| A_{O} | friction contact area in oblique |
| | direction |
| σ_{S} | pressure stress in shaving direction |
| σ_{P} | pressure stress in perpendicular |
| | direction |
| σ_{O} | pressure stress in oblique direction |
| 10 | skin-contacting surface |
| 11 | variable friction resistance element |
| 12 | structured protrusions |
| 13 | corrugated shape |
| 14 | peaks |
| 15 | depressions |
| 16 | flat shape |
| 17 | struts |
| 20 | razor cartridge |
| 21 | frame |
| 22 | platform member |
| 23 | guard member |
| 24 | leading longitudinal member |
| 25 | trailing longitudinal member |
| 26 | first retainer |
| 27 | second retainer |
| 28 a-d | cutting member |
| 29 | cap member |
| 30 a-d | cutting edge |
| 31 | cutting member receiving section |
| 32 | blade support |
| 33 a-d | blade |
| 34 a-d | holding slot |
| 35 | shaving direction frame member |
| 36 a-d | cutting member guide |
| 38 a-d | resilient finger |
| 49 | longitudinal trailing assembly |
| 50 | skin care element |
| 53 | trimming blade assembly |
| 54 | trimming blade support |
| 60 | skin contacting member |
| 61 | leading skin contacting surface |
| 62 | trailing skin contacting surface |
| 64 | lateral skin contact surfaces |
| 100 | razor |
| 200 | razor handle |
| 210 | proximal portion |
| 220 | distal portion |
| 230 | coupling |
| 240 a, b | releasing mechanism |
| 250 | handle grip |
| 260 | de-tensioning device |

1-46. (canceled)

47. A razor cartridge, comprising:
a skin-contacting surface configured to contact a user's skin surface (K) during a shaving operation,
wherein the skin-contacting surface includes a variable friction resistance element having a frictional resistance which is dependent on a motion direction of the razor cartridge over the user's skin surface (K),
wherein the razor cartridge defines a shaving direction (S) and a perpendicular direction (P),
wherein the variable friction resistance element is adapted to prevent movement in the perpendicular direction (P) such that when the razor cartridge moves in the perpendicular direction (P) the variable friction resistance element is transitioned to an engaged state, wherein in the engaged state the variable friction resistance element is configured to increase a friction contact area of the razor cartridge with the skin surface (K).

48. The razor cartridge according to claim 47, wherein the variable friction resistance element is adapted to allow movement in the shaving direction (S) such that when the razor cartridge moves in the shaving direction (S), the frictional resistance is reduced compared to the frictional resistance when the razor cartridge moves in the perpendicular direction (P).

49. The razor cartridge according to claim 47, wherein the variable friction resistance element is adapted to allow movement in the shaving direction (S) such that when the razor cartridge moves in the shaving direction (S), the variable friction resistance element is in a relaxed state.

50. The razor cartridge according to claim 47, wherein in the engaged state, the variable friction resistance element is tensioned against the skin surface (K).

51. The razor cartridge according to claim 49, wherein in the relaxed state, the variable friction resistance element is configured to reduce a friction contact area with the skin surface (K).

52. The razor cartridge according to claim 47, wherein in the engaged state, a shape change is induced in the variable friction resistance element.

53. The razor cartridge according to claim 47, wherein the razor cartridge defines a direction (Z) that is perpendicular to a plane (SCP) defined by the shaving direction (S) and the perpendicular direction (P) in the skin-contacting surface.

54. The razor cartridge according to claim 53, wherein the variable friction resistance element comprises a corrugated shape in the skin-contacting plane (SCP).

55. The razor cartridge according to claim 54, wherein the corrugated shape has peaks with a smooth surface and depressions with the structured protrusions.

56. The razor cartridge according to claim 54, wherein in the engaged state, the corrugated shape transitions to a flat shape.

57. The razor cartridge according to claim 47, wherein the variable friction resistance element comprises a plurality of structured protrusions.

58. The razor cartridge according to claim 57, wherein the plurality of structured protrusions has a concertina patterning of ridges.

59. The razor cartridge according to claim 47, wherein the variable friction resistance element comprises a shape change component.

60. The razor cartridge according to claim 59, wherein the shape change component is adapted to provoke a shape change in the variable friction resistance element, in particular a shape-change of the plurality of structured protrusions, wherein the plurality of structured protrusions is shifted into a tensioned state.

61. The razor cartridge according to claim 59, wherein the shape change component is adapted to actuate the plurality of structured protrusions.

62. The razor cartridge according to claim 59, wherein the shape change component is activated when moving the cartridge in the perpendicular direction (P).

63. The razor cartridge according to claim 59, wherein the shape change component is adapted to provoke a shape change in the variable friction resistance element, in particular a shape-change of the plurality of structured protrusions, wherein the plurality of structured protrusions is shifted into a tensioned state.

64. The razor cartridge according to claim 59, wherein the shape change component is adapted to actuate the plurality of structured protrusions.

65. A kit of parts, comprising:
a razor cartridge holder comprising a plurality of razor cartridges according to claim 47.

66. A skin contacting member connectable to a razor cartridge, wherein the skin contacting member comprises a skin-contacting surface configured to contact a user's skin surface (K) during a shaving operation,
wherein the skin-contacting surface includes a variable friction resistance element having a frictional resistance which is dependent on a motion direction of the skin contacting member when mounted on the razor cartridge and moving over the user's skin surface (K),
wherein the skin contacting member when mounted on the razor cartridge and moving over the user's skin surface (K) defines a shaving direction (S) and a perpendicular direction (P),
wherein the variable friction resistance element is adapted to prevent movement in the perpendicular direction (P) such that when the skin contacting member moves in the perpendicular direction (P) the variable friction resistance element is transitioned to an engaged state, wherein in the engaged state the variable friction resistance element is configured to increase a friction contact area of the skin contacting member with the skin surface (K).
